(19) United States
(12) Patent Application Publication
(10) Pub. No.: US 2025/0200397 A1
(43) Pub. Date: Jun. 19, 2025

(54) MACHINE LEARNING APPARATUS, MACHINE LEARNING METHOD, AND MACHINE LEARNING PROGRAM FOR LEARNING DATA OF A NOVEL CLASS WITH A SMALLER NUMBER OF SAMPLES THAN DATA OF A BASE CLASS BY CONTINUAL LEARNING

(71) Applicant: JVCKENWOOD Corporation, Yokohama-shi (JP)

(72) Inventor: Shun NISHIMAKI, Yokohama-shi (JP)

(21) Appl. No.: 19/066,227

(22) Filed: Feb. 28, 2025

Related U.S. Application Data
(63) Continuation of application No. PCT/JP2023/018053, filed on May 15, 2023.

(30) Foreign Application Priority Data
Aug. 31, 2022 (JP) 2022-137820

(51) Int. Cl. G06N 5/022; G06F 18/241

(52) U.S. Cl. CPC G06N 5/022; G06F 18/241

(57) ABSTRACT

In a machine learning apparatus that learns data of a novel class with a smaller number of samples than data of a base class by continual learning, a feature extraction unit is pre-trained using the data of the base class. The feature extraction unit receives an input of the data of the novel class to output a feature vector of the data of the novel class. A weight calculation unit calculates a classification weight of the novel class based on the feature vector. A graph model receives an input of the classification weight of the novel class and classification weights of all classes previously learned to output reconstructed classification weights. The graph model is trained by pseudo continual learning using alternative data of the base class to learn a dependency between the base class and the novel class by meta learning.

### CROSS-REFERENCE TO RELATED APPLICATION

This application is a continuation of application No. PCT/JP2023/018053, and claims the benefit of priority from the prior Japanese Patent Application No. 2022-137820, filed on Aug. 31, 2022, the entire contents of which is incorporated herein by reference.

### BACKGROUND

### 1. Field of the Invention

The present disclosure relates to machine learning technologies.

### 2. Description of the Related Art

Human beings can learn new knowledge through experiences over a long period of time and can maintain old knowledge without forgetting it. Meanwhile, the knowledge of a convolutional neutral network (CNN) depends on the dataset used in learning. To adapt to a change in data distribution, it is necessary to re-learn CNN parameters in response to the entirety of the dataset.

A more efficient and practical method available is incremental learning or continual learning in which new tasks are learned, reusing the knowledge already acquired. In particular, continual learning in a classification task is a method that allows migration from a state in which classification into base classes (classes learned in the past) is enabled to a state in which new classes (novel classes) can be learned for classification.

Meanwhile, there is a phenomenon in deep learning called catastrophic forgetting in which the knowledge acquired in the past is considerably lost, and the ability for tasks is considerably reduced. This presents a problem in continual learning in particular. In continual learning in a classification task, the biggest challenge is to suppress catastrophic forgetting and maintain the performance for base class classification while at the same time acquiring the performance for novel class classification.

On the other hand, new tasks often have only a limited number of sample data items available. Therefore, few-shot learning has been proposed as a method to efficiently learn from a small amount of training data. Normally, several thousands samples are necessary for learning. In few-shot learning, however, a task is learned by using a small number of samples (e.g., several samples).

Further, class incremental learning (CIL) has been proposed to additionally train a model already trained on a basic (base) class, thereby enabling classification into a new class (novel class). In CIL, tasks are continually added to a model trained for classification, and new tasks require classification performance for novel classes and past classes. Normally, training data for new tasks is big data.

A method called few-shot class incremental learning (FSCIL) has been proposed, which combines continual learning, in which a novel class is learned without catastrophic forgetting of the result of learning the basic (base) class, with few-shot learning, in which a novel class with fewer samples as compared to the base class is learned (Non-Patent Literature 1). In incremental few-shot learning, the base class can be learned from a large-scale dataset, while the novel class can be learned from a small number of sample data items. FSCIL is an incremental learning scenario for classification similar to CIL but significantly differs in that the number of samples in the training data of the novel class is small (small data).

CEC (continually evolved classifiers) have been proposed as incremental few-shot learning method (Non-Patent Literature 1). CEC constructs a pseudo-continual learning task and trains a graph attention network (GAT) by using a base class image produced by rotating an original image as a pseudo novel class image.
[Non-Patent Literature 1] Zhang, C., Song, N., Lin, G., Zheng, Y., Pan, P., & Xu, Y. (2021). Few-shot incremental learning with continually evolved classifiers. In Proceedings of the IEEE/CVF Conference on Computer Vision and Pattern Recognition (pp. 12455-12464)

### SUMMARY

In the method described in Non-Patent Literature 1, feature representations for classification of a base class image have already been learned. It may therefore be impossible to train a graph model sufficiently by using an image merely produced by rotating a learned image. Accordingly, there has been a problem in that sufficient classification accuracy cannot be obtained.

A machine learning apparatus according to an embodiment of the present disclosure is a machine learning apparatus that learns data of a novel class with a smaller number of samples than data of a base class by continual learning, including: a feature extraction unit that is pre-trained using the data of the base class and that receives an input of the data of the novel class to output a feature vector of the data of the novel class; a weight calculation unit that calculates a classification weight of the novel class based on the feature vector; and a graph model that receives an input of the classification weight of the novel class calculated and classification weights of all classes previously learned and is caused to adapt and reconstruct the classification weights thus input and to output reconstructed classification weights, the graph model being trained by pseudo continual learning using alternative data of the base class generated based on a plurality of data items of the base class to learn a dependency between the base class and the novel class by meta learning.

A machine learning method of an embodiment of the present disclosure is a machine learning apparatus that learns data of a novel class with a smaller number of samples than data of a base class by continual learning, including: inputting the data of the novel class to a feature extraction unit pre-trained on the data of the base class, thereby causing the feature extraction unit to output a feature vector of the data of the novel class; calculating a classification weight of the novel class based on the feature vector; and inputting the classification weight of the novel class calculated and classification weights of all classes previously learned to a graph model trained by pseudo continual learning using alternative data of the base class generated based on a plurality of data items of the base class to learn a dependency between the base class and the novel class by meta learning, and causing the graph model to adapt and reconstruct the classification weights thus input and to output reconstructed classification weights.

A machine learning program according to an embodiment of the present disclosure is a machine learning program for learning data of a novel class with a smaller number of samples than data of a base class by continual learning, the program including computer-implemented modules including: a module that inputs the data of the novel class to a feature extraction unit pre-trained on the data of the base class, thereby causing the feature extraction unit to output a feature vector of the data of the novel class; a module that calculates a classification weight of the novel class based on the feature vector; and a module that inputs the classification weight of the novel class calculated and classification weights of all classes previously learned to a graph model trained by pseudo continual learning using alternative data of the base class generated based on a plurality of data items of the base class to learn a dependency between the base class and the novel class by meta learning, and causes the graph model to adapt and reconstruct the classification weights thus input and to output reconstructed classification weights.

Optional combinations of the aforementioned constituting elements, and implementations of the present disclosure in the form of methods, apparatuses, systems, recording mediums, and computer programs may also be practiced as additional embodiments.

### BRIEF DESCRIPTION OF DRAWINGS

Embodiments will now be described by way of examples only, with reference to the accompanying drawings which are meant to be exemplary, not limiting and wherein like elements are numbered alike in several Figures in which:

FIGS. 1A-1C illustrate intertask confusion;

FIG. 2 illustrates a conventional CEC method;

FIG. 3 is a functional block diagram for explaining a configuration of the pseudo-continual learning module of the conventional machine learning apparatus that uses CEC;

FIG. 4 is a functional block diagram for explaining a configuration of the novel class learning module of the conventional machine learning apparatus that uses CEC;

FIGS. 5A and 5B are graphs showing the average classification accuracy with respect to the rotation angle;

FIG. 6 is a functional block diagram showing the pseudo-continual learning module of the first embodiment;

FIG. 7 is a flowchart showing an image synthesis process of the pseudo-continual learning module of the first embodiment;

FIG. 8 is a functional block diagram showing the pseudo-continual learning module of the second embodiment;

FIG. 9 is a flowchart illustrating the image generation process performed by the pseudo-continual learning module of the second embodiment;

FIG. 10 is a functional block diagram showing the pseudo-continual learning module of the third embodiment; and

FIG. 11 illustrates the CEC method of the fourth embodiment.

### DETAILED DESCRIPTION

The invention will now be described by reference to the preferred embodiments. This does not intend to limit the scope of the present invention, but to exemplify the invention.

Before describing embodiments, an outline of FSCIL and CEC in the related art will be described. First, FSCIL will be described. FSCIL is a method of continually learning the knowledge of a new class (novel class) with a small amount of data without forgetting the knowledge of the old class (base class, basic class). FSCIL uses training data (small data) for a small number of new tasks, and so it is more difficult to train a model properly than in CIL. Meanwhile, FSCIL is a more realistic scenario because it does not need to collect a large amount of data. On the other hand, FSCIL has a problem of forgetting the base class as well as a problem of intertask confusion.

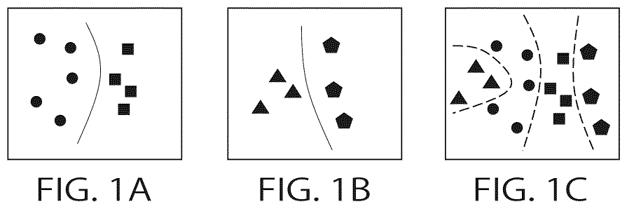

FIGS. 1A-1C illustrate intertask confusion. FIG. 1A shows an example of classification into class 1 (circles in the figure) and class 2 (squares in the figure). FIG. 1B shows an example of classification into class 3 (triangles in the figure) and class 4 (pentagons in the figure). FIG. 1C shows an example of classification into classes 1-4.

It is assumed that, as shown in FIGS. 1A and 1B, the classification into class 1 and class 2 and classification into class 3 and class 4 are made possible by continual learning of data of novel classes in FSCIL. However, classification into the entire classes 1-4 is not learned in this case so that the classifier trained in this way may not be able to properly classify into the four classes of class 1-4 as shown in FIG. 1C. This is called intertask confusion.

A description will now be given of CEC. CEC is a type of the FSCIL method. CEC is a method to address forgetting of the base class and intertask confusion, which are challenges of FSCIL. In particular, CEC addresses intertask confusion by propagating contextual information between classifiers trained in individual sessions, using a graph model in which a feature extractor and a classifier are separated and which is optimized by being trained on an episode of pseudo-continual learning tasks constructed from a base class dataset. Hereinafter, the conventional CEC method will be described.

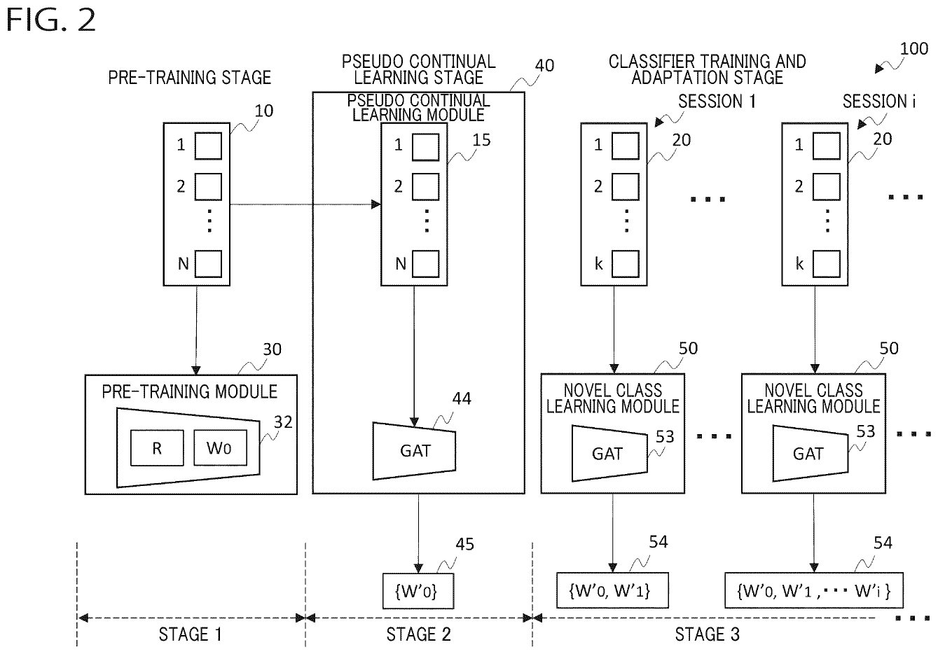

FIG. 2 illustrates a conventional CEC method. As shown in FIG. 2, CEC consists of stages 1-3. The conventional machine learning apparatus 100 includes a pre-training module 30 used in stage 1, a pseudo-continual learning module 40 used in stage 2, and a novel class learning module 50 used in stage 3.

Stage 1 is the pre-training stage. In stage 1, a large amount of base class datasets (hereinafter referred to as basic datasets) 10 are used to pre-train the weights of a backbone CNN 32 of the pre-training module 30 in standard supervised training by the pre-training module 30. The basic dataset 10 includes N data samples. Examples of data samples include, but are not limited to, image data. In the case of the CIFAR100 dataset, for example, the basic dataset 10 includes image data for 60 classes×500 images. The basic dataset 10 may include datasets of a plurality of different classes. The backbone CNN 32 is a convolutional neural network that has been pre-trained on the basic dataset 10. The backbone CNN 32 includes a weight of a feature extractor R and a base class classification weight W0, which is a weight vector of the base class classifier. The base class classification weight W0 indicates the average feature amount of the data sample of the basic dataset 10. By fixing the parameter of the feature extractor R of the pre-trained backbone CNN 32 in subsequent stages, forgetting of the base class is suppressed.

Stage 2 is the pseudo-continual learning stage. In stage 2, the weight of a GAT 44 is learned in the pseudo-continual learning module 40 to propagate the context information of each class and generate a classifier adapted to all classes. Learning in the GAT 44 is performed in an episodic format by constructing a pseudo-continual learning task from a dataset for a rotated image generated by rotating an image of the basic dataset 10. Hereinafter, the dataset generated based on the basic dataset 10 in the pseudo-continual learning stage will be referred to as a pseudo dataset 15.

In stage 2, the base class classification weight is learned based on the feature vector generated by inputting the pseudo dataset 15, which is an alternative dataset of the base class to the feature extractor R of the backbone CNN 32 pre-trained in stage 1. By inputting the base class classification weight W0 learned in stage 1 and the base class classification weight learned in stage 2 to the GAT 44 of the pseudo-continual learning module, the GAT 44 is caused to adapt and reconstruct these base class classification weights and to output reconstructed classification weights. Hereinafter, the reconstructed classification weights output from the GAT will be referred to as reconstructed classification weights.

A description will now be given of the episodic format. Each episode consists of a support set and a query set. In the pseudo-continual learning stage, each of the support set and the query set consists of the basic dataset 10 and the pseudo dataset 15. In stage 2, the query samples in both the basic dataset 10 and the pseudo dataset 15 included in the query set are classified based on the support samples of the given support set in each episode, and the parameters of the GAT 44 are updated to minimize the loss in classification.

It should be noted here that the rotated image of the base class is used in the pseudo-continual learning task because the backbone CNN 32 has already learned in stage 1 the feature representation for properly classifying the image of the base class so that the GAT 44 is not properly trained if the image of the base class is used as it is. The parameters of the GAT 44 after training are fixed in the subsequent stages.

Stage 3 is the classifier training and adaptation stage. In stage 3, a novel class dataset with a small number of samples (hereinafter referred to as new dataset) 20 given for each session is used in the novel class learning module 50 to train the classifier, and all classifiers trained in the current session and previous sessions are input to a GAT 53 of the novel class learning module 50. Thereby, all classifiers are adapted to the dataset. The GAT 53 of the novel class learning module 50 is the GAT trained in the pseudo-continual learning stage. Query inference is performed by the classifier adapted to the dataset by the GAT 53. The new dataset 20 includes k data samples, which is fewer than the number of samples in the basic dataset 10. The new dataset 20 may include datasets of a plurality of different classes.

In stage 3, a novel class classification weight is learned for each session based on the feature vector generated by inputting the new dataset 20 to the feature extractor R of the backbone CNN 32 pre-trained in stage 1. By inputting the W′0 reconstructed classification weights of 45 generated in stage 2 and all novel class classification weights {W1, . . . , Wi} learned in each session up to the i-th session in stage 3 to the GAT 53 of the novel class learning module 50, classification weights of all classes input to the GAT 53 are adapted and reconstructed. The reconstructed classification weights 54 of {W′0, W′1, . . . , W′i} are output from the GAT 53.

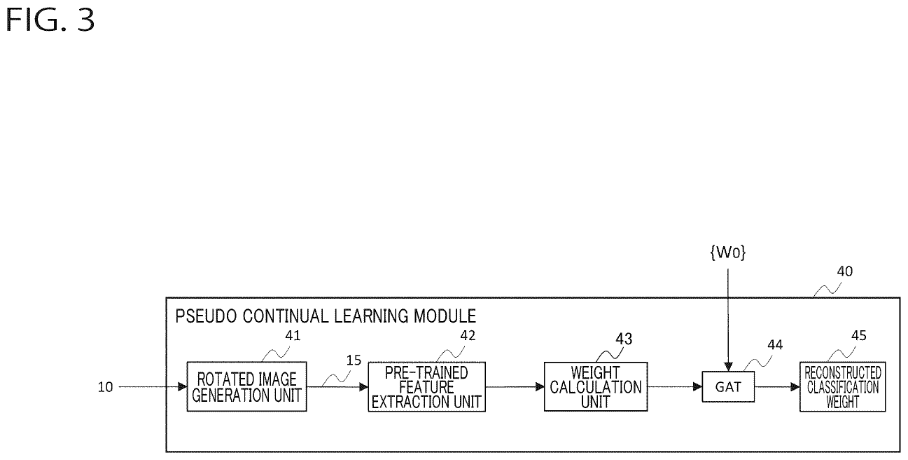

FIG. 3 is a functional block diagram for explaining a configuration of the pseudo-continual learning module 40 of the conventional machine learning apparatus 100 that uses CEC. The pseudo-continual learning module 40 includes a rotated image generation unit 41, a pre-trained feature extraction unit 42, a weight calculation unit 43, and a GAT 44.

The rotated image generation unit 41 generates a pseudo dataset 15 for a rotated image by rotating an image of the basic dataset 10 used in the pre-training module 30 and supplies the pseudo dataset 15 to the pre-trained feature extraction unit 42.

The pre-trained feature extraction unit 42 of the pseudo-continual learning module 40 extracts the feature vector of the pseudo dataset 15 using the pseudo dataset 15 as the input and supplies the extraction result to the weight calculation unit 43. The pre-trained feature extraction unit 42 of the pseudo-continual learning module 40 is identical to the feature extractor R of the backbone CNN 32 pre-trained to learn the base class classification weights in stage 1.

The weight calculation unit 43 of the pseudo-continual learning module 40 averages the feature vectors of the pseudo dataset 15 for each class, calculates the base class classification weights of the pseudo dataset 15, and supplies the weights to the GAT 44.

The base class classification weight W0 of the backbone CNN 32 pre-trained on the base class classification weight in stage 1 and the base class classification weight W0 of the pseudo dataset 15 supplied from the weight calculation unit 43 are input to the GAT 44 of the pseudo-continual learning module 40. The GAT 44 learns the dependency between the basic dataset 10 and the pseudo dataset 15 by meta learning and outputs the reconstructed classification weights by adapting classification weight of all classes input to the dataset. In the pseudo-continual learning module 40, the GAT as a meta-module is trained in an episodic format. Using a query set consisting of the basic dataset 10 and the pseudo dataset 15, the parameters of the GAT 44 are optimized and updated for each episode. The method described in Non-Patent Literature 1 is used to optimize the GAT 44.

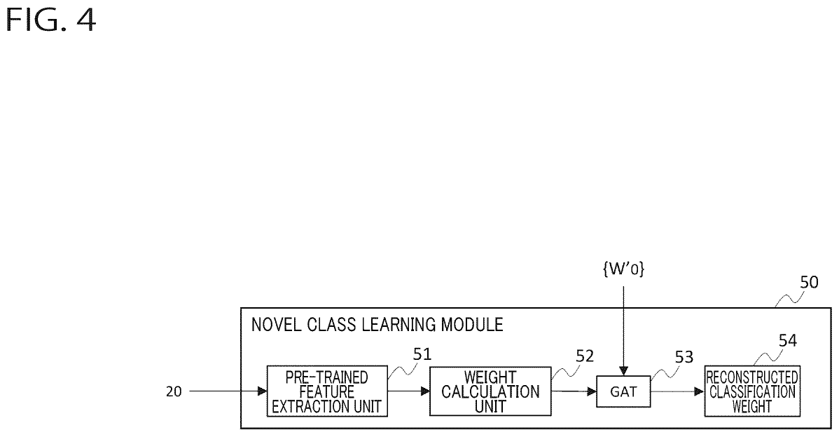

FIG. 4 is a functional block diagram for explaining a configuration of the novel class learning module 50 of the conventional machine learning apparatus 100 that uses CEC. The novel class learning module 50 includes a pre-trained feature extraction unit 51, a weight calculation unit 52, and a GAT 53.

The pre-trained feature extraction unit 51 of the novel class learning module 50 receives the input of the new dataset 20, extracts the feature vector of the new dataset 20, and supplies the extraction result to the weight calculation unit 52 of the novel class learning module 50. The pre-trained feature extraction unit 51 of the novel class learning module 50 is identical to the feature extractor R of the backbone CNN 32 pre-trained in stage 1.

The weight calculation unit 52 of the novel class learning module 50 averages the feature vectors of the new dataset 20 for each class, calculates the novel class classification weights of the new dataset 20, and supplies the weights to the GAT 53 of the novel class learning module 50.

The W′0 reconstructed classification weights 45 generated in stage 2 and the novel class classification weights {W1, . . . , Wi} supplied from the weight calculation unit 52 of the novel class learning module 50 are input to the GAT 53 of the novel class learning module 50. The GAT 53 learns the dependency between the basic dataset 10 and the new dataset 20 by meta learning and outputs the reconstructed classification weights 54 by adapting classification weights of all classes to the dataset. The GAT 53 of the novel class learning module 50 is identical to the meta-trained GAT 44 of the pseudo-continual learning module 40.

It will be noted that there is a constraint in the pseudo-continual learning stage of CEC in that the new dataset 20 cannot be used as the pseudo dataset 15. In the conventional machine learning apparatus 100, therefore, an image produced by rotating an image of the basic dataset 10 is used as the pseudo dataset 15. Meanwhile, in stage 1, the feature extractor R of the backbone CNN 32 learns a feature representation for proper classification into the base class, and, in stage 2, the GAT 44 learns from the image produced by merely rotating the image of the basic dataset 10. Conventionally, therefore, the GAT 44 is only trained in the same manner as the backbone CNN 32 using an image generated based on one image of the basic dataset 10 and so may not possibly be trained sufficiently.

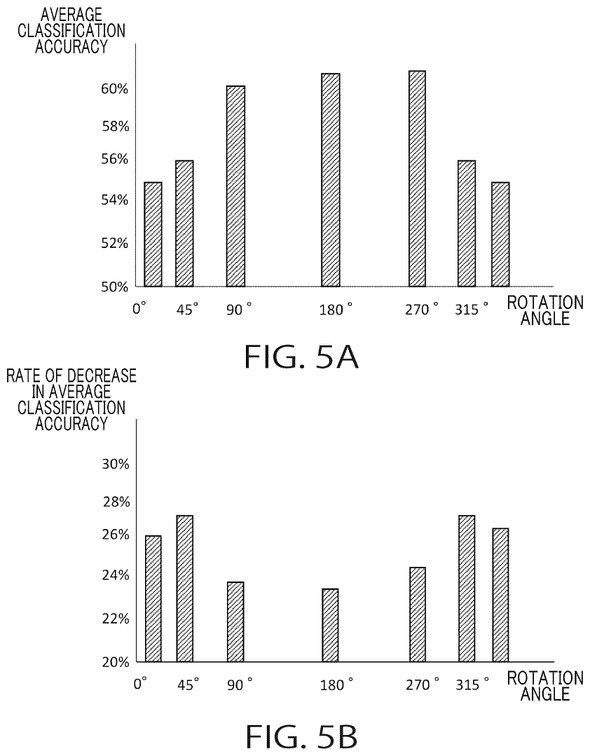

FIG. 5 is a graph showing the classification accuracy plotted against the rotation angle of the image of the base class used to train the GAT in conventional CEC. FIG. 5A shows the average classification accuracy with respect to the rotation angle, and FIG. 5B shows a rate of decrease in the average classification accuracy from the initial session to the final session plotted against the rotation angle. It can be confirmed from FIG. 5A that the classification accuracy is high when the rotation angle is 90°, 180°, and 270°. It can also be seen from FIG. 5B that the rate of decrease in the average classification accuracy from the initial session to the final session is small, and the forgetting of the base class is suppressed when the rotation angle is 90°, 180°, and 270°. Based on this, it is considered to be desirable in pseudo-continual learning to use an image that is visually remote from an image of the base class from the viewpoint of improving classification accuracy.

We focus on pseudo-continual learning in stage 2 and propose to newly generate an alternative data of the base class significantly different from the basic dataset used to train the backbone CNN 32 based on a plurality of datasets of the base class and to construct a pseudo-continual learning task for the GAT 44 of the pseudo-continual learning module 40. Hereinafter, embodiments will be described.

### First Embodiment

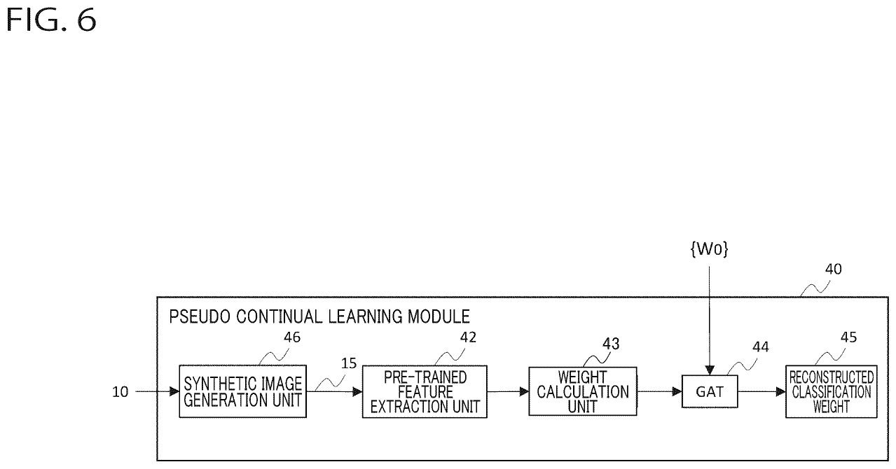

FIG. 6 is a functional block diagram showing the pseudo-continual learning module 40 of the machine learning apparatus 100 of the first embodiment. The pseudo-continual learning module 40 of the machine learning apparatus 100 of the first embodiment includes a synthetic image generation unit 46, a pre-trained feature extraction unit 42, a weight calculation unit 43, and a GAT 44. The basic dataset 10 and the new dataset 20 of this embodiment are image data, but the embodiment is not limited thereto. In the pseudo-continual learning module 40 of the conventional machine learning apparatus 100, the rotated image generation unit 41 is used. However, the synthetic image generation unit 46 is used instead of the rotated image generation unit 41 in the pseudo-continual learning module 40 of the machine learning apparatus 100 of the first embodiment. The features, including the pre-training module 30 and the novel class learning module 50, of the machine learning apparatus 100 of the first embodiment other than the synthetic image generation unit 46 are the same as those of the conventional machine learning apparatus 100 so that the difference will be mainly described, and a description of common features will be omitted as appropriate.

The synthetic image generation unit 46 rotates images of a plurality of data items of the base class and generates a synthetic image by combining the plurality of rotated images. The synthetic image of this embodiment is an example of the alternative data of the base class generated based on a plurality of data items of the base class. In this embodiment, the synthetic image generation unit 46 combines two images, but may combine two or more images. Further, the images to be synthesized may be of the same class or different classes. The synthetic image of this embodiment is an example of the alternative data of the base class.

The synthetic image generation unit 46 of the first embodiment generates a synthetic image using the CutMix method. CutMix is a method of generating a new image by pasting a portion of another image to a given image, wherein the label is the area ratio between the two images. The rotation angle of each image may be used as the label. The embodiment is not limited thereto, and the synthetic image generation unit 46 may synthesize images using a method such as Mixup or Cutout. Mixup is a method of overlaying a pair of images according to the weights, and the label is determined by the weights. Cutout is a method of masking a portion of an image with an image of a square area, and the label is the same as before the synthesis.

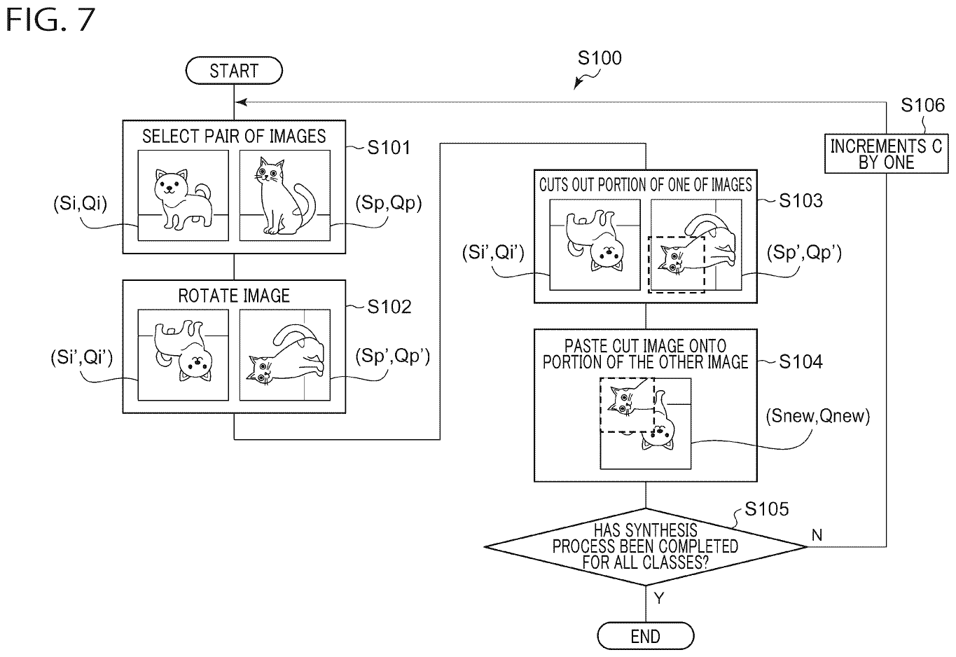

FIG. 7 is a flowchart showing an image synthesis process S100 of the pseudo-continual learning module 40.

In step S101, the synthetic image generation unit 46 randomly selects a pair of images from the basic dataset 10. In this embodiment, each data in the basic dataset 10 is sequenced in each class. For example, the synthetic image generation unit 46 randomly selects a training set (Sp, Qp) that pairs with a training set (Si, Qi) of the c-th class of the base class from the class in the same episode. In this case, Si and Sp are support samples, and Qi and Op are query samples. The order c starts with 1, which is incremented in steps of 1 in step S106 described later. In step S101 of FIG. 7, an image of a dog (Si, Qi) is selected as a training set in the c-th class, and an image of a cat (Sp, Qp) is selected to form a pair.

In step S102, the synthetic image generation unit 46 randomly rotates the dog image (Si, Qi) and the cat image (Sp, Qp) thus selected. For example, the synthetic image generation unit 46 randomly sets the angle by which the dog image (Si, Qi) and the cat image (Sp, Op) are respectively rotated from 90°, 180°, and 270°. For example, the synthetic image generation unit 46 rotates the dog image (Si, Qi) and the cat image (Sp, Op) by the rotation angle thus set so as to generate a rotated image of the dog (Si′, Qi′) and a rotated image of the cat (Sp′, Qp′). In the example of FIG. 7, the dog image (Si, Qi) is rotated 180° and the cat image (Sp, Op) is rotated 90°. The rotated dog image (Si′, Qi′) and the rotated cat image (Sp′, Qp′) will be a pair of images synthesized.

In step S103, the synthetic image generation unit 46 cuts out a portion of one of the rotated dog image (Si′, Qi′) and the rotated cat image (Sp′, Qp′). In the example of FIG. 7, a portion of the rotated cat image (Sp′, Qp′) is cut out.

In step S104, the synthetic image generation unit 46 generates a synthetic image (Snew, Qnew) by pasting the cut image onto a portion of the other image. In the example of FIG. 7, a synthetic image (Snew, Qnew) is generated by pasting a portion of the cut rotated cat image (Sp′, Qp′) onto a portion of the rotated dog image (Si′, Qi′).

In step S105, the synthetic image generation unit 46 determines whether the synthesis process is completed for all classes. When the synthesis process of steps S101-S104 is completed for all classes (Y in step S105), the construction of the pseudo-continual learning task of the first embodiment is completed, and the image synthesis process S100 ends. When the synthesis process is not completed for all classes (N in step S105), the image synthesis process S100 proceeds to step S106.

In step S106, the synthetic image generation unit 46 increments the order c of the base class by one. Thereafter, the image synthesis process S100 returns to step S101, and steps S101-S105 are executed on the dataset of the next class of the base class. Steps S101-S106 are repeated until the synthesis process is completed for all classes.

According to the first embodiment, it is possible, by synthesizing the data, to train the GAT 44 with unknown data that is significantly different from the data used to pre-train the backbone CNN 32. As a result, the GAT 44 can be trained more effectively, and the classification accuracy of the machine learning apparatus 100 can be further improved.

The synthetic image of the first embodiment is obtained by synthesizing images obtained by rotating the image of the basic dataset 10, but the embodiment is not limited thereto. The image of the basic dataset 10 may be synthesized without being rotated. Hereinafter, the term synthetic image shall encompass a synthesis of rotated images and a synthesis of non-rotated images.

### Second Embodiment

Hereinafter, a second embodiment of the present invention will be described. In the drawings and description of the second embodiment, the same or equivalent constituting elements as those of the first embodiment are denoted by the same reference numerals. Duplicative explanations from the first embodiment are omitted as appropriate, and features different from those of the first embodiment will be highlighted.

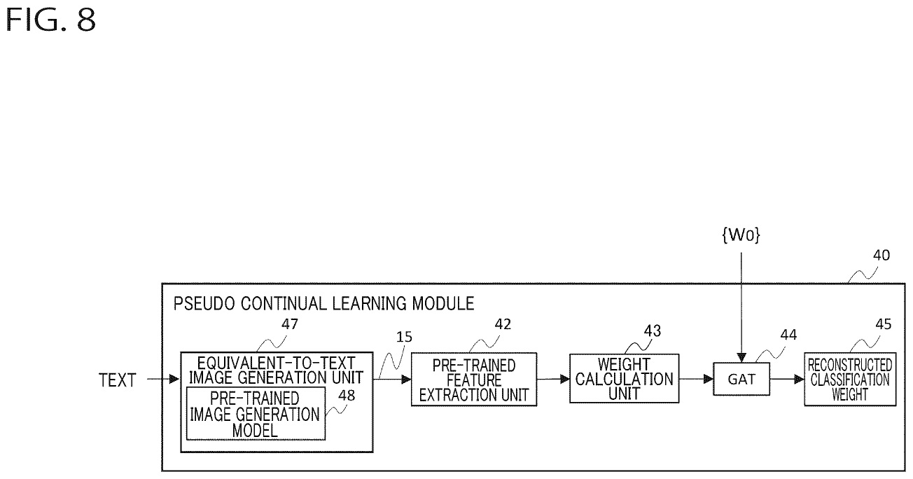

FIG. 8 is a functional block diagram showing the pseudo-continual learning module 40 of the machine learning apparatus 100 of the second embodiment. The pseudo-continual learning module 40 of the machine learning apparatus 100 of the second embodiment includes an equivalent-to-text image generation unit 47, a pre-trained feature extraction unit 42, a weight calculation unit 43, and a GAT 44. The equivalent-to-text image generation unit 47 includes a pre-trained image generation model 48. In the pseudo-continual learning module 40 of the machine learning apparatus 100 of the first embodiment, the synthetic image generation unit 46 is used. However, the equivalent-to-text image generation unit 47 and the pre-trained image generation model 48 are used instead of the synthetic image generation unit 46 in the pseudo-continual learning module 40 of the machine learning apparatus 100 of the second embodiment. The GATs 44 and 53 of this embodiment are examples of the graph model. Since the features other than the equivalent-to-text image generation unit 47 and the pre-trained image generation model 48 of the machine learning apparatus 100 of the second embodiment are basically the same as those of the machine learning apparatus 100 of the first embodiment, the difference will be mainly described, and a description of the common features will be omitted as appropriate.

By inputting text data describing the base class to the pre-trained image generation model 48, the equivalent-to-text image generation unit 47 generates an equivalent-to-text image corresponding to the text data. The pre-trained image generation model 48 is a text-to-image image generation model that receives text data as an input and outputs an equivalent-to-text image corresponding to the content of the text data. Examples of this image generation model method include StackGAN++. The pre-trained image generation model 48 is pre-trained using a plurality of data items of the base class. Thus, the equivalent-to-text is generated based on a plurality of data items of the base class. The equivalent-to-text image of this embodiment is an example of the alternative data of the base class.

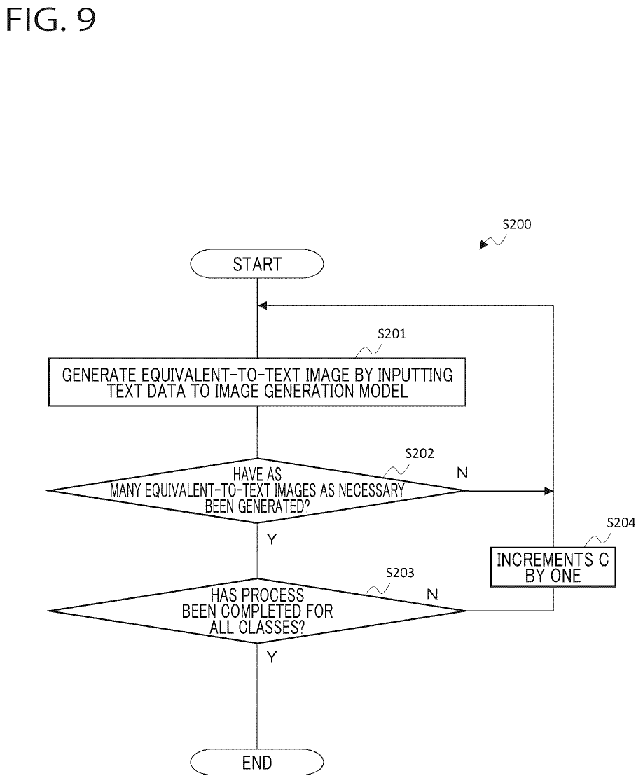

FIG. 9 is a flowchart illustrating the image generation process S200 performed by the pseudo-continual learning module 40 of the second embodiment.

In step S201, the equivalent-to-text image generation unit 47 generates an equivalent-to-text image by inputting text data corresponding to the c-th class of the basic dataset 10 to the pre-trained image generation model 48. When the c-th class is “cat”, for example, “cat” is input to the pre-trained image generation model 48 as text data, and an image of “cat” is output from the pre-trained image generation model 48. The label of the image generated by the equivalent-to-text image generation unit 47 is the input text data.

In step S202, the equivalent-to-text image generation unit 47 determines whether as many equivalent-to-text images as necessary for the support set and the query set have been generated for one class. When as many equivalent-to-text image as described above are generated (Y in step S202), the image generation process S200 proceeds to step S203. When as many equivalent-to-text images as described above are not generated (N in step S202), the image generation process S200 returns to step S201. In step S201, another image of the same class is generated, and steps S201 and S202 are repeated until as many equivalent-to-text images as described above are generated (Y in step S202).

In step S203, the equivalent-to-text image generation unit 47 determines whether the equivalent-to-text image generation process is completed for all classes. When the equivalent-to-text image generation process of steps S201-S202 is completed for all classes (Y in step S203), the construction of the pseudo-continual learning task of the second embodiment is completed, and the image generation process S200 ends. When the equivalent-to-text image generation process is not completed for all classes (N in step S203), the image generation process S200 proceeds to step S204.

In step S204, the equivalent-to-text image generation unit 47 increments the order c of the base class by one. Subsequently, the image generation process S200 returns to step S201, and steps S201-S203 are executed on the dataset of the next class of the base class. Steps S201-S204 are repeated until the equivalent-to-text image generation process is completed for all classes.

According to the second embodiment, the GAT 44 can be trained with unknown data that is not used in the pre-training of the backbone CNN 32, by newly generating base class data from the image generation model pre-trained using a plurality of base class data items. As a result, the GAT 44 can be trained more effectively, and so it is possible to further improve the classification accuracy of the machine learning apparatus 100.

In the second embodiment, the equivalent-to-text image is used as the alternative data of the base class, but the embodiment is not limited thereto, and an image produced by rotating the equivalent-to-text image may be used.

### Third Embodiment

Hereinafter, a third embodiment of the present invention will be described. In the drawings and description of the third embodiment, the same or equivalent constituting elements as those of the first and second embodiments are denoted by the same reference numerals. Duplicative explanations from the first and second embodiments are omitted as appropriate, and features different from those of the first and second embodiments will be highlighted.

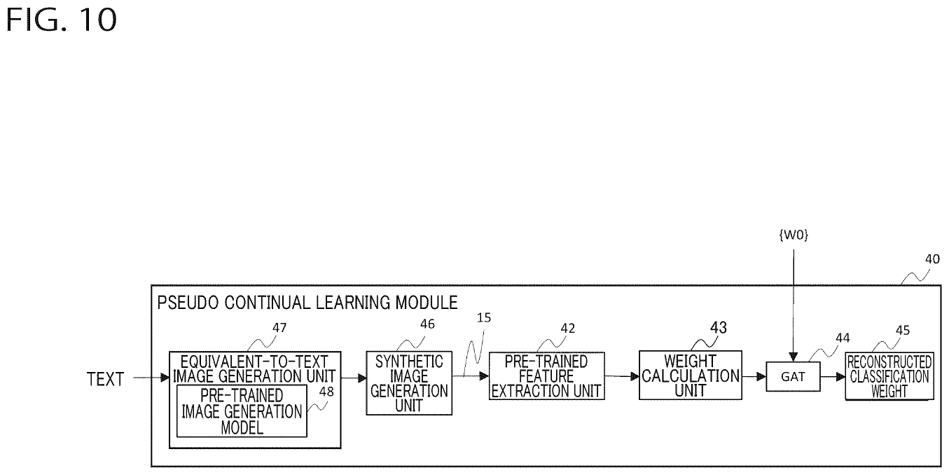

FIG. 10 is a functional block diagram showing the pseudo-continual learning module 40 of the machine learning apparatus 100 of the third embodiment. The pseudo-continual learning module 40 of the machine learning apparatus 100 of the third embodiment includes an equivalent-to-text image generation unit 47, a synthetic image generation unit 46, a pre-trained feature extraction unit 42, a weight calculation unit 43, and a GAT 44. The equivalent-to-text image generation unit 47 of the third embodiment supplies the generated equivalent-to-text image to the synthetic image generation unit 46. The synthetic image generation unit 46 of the third embodiment generates a synthetic image by synthesizing the equivalent-to-text image and supplies the synthetic image to the pre-trained feature extraction unit 42. The synthetic image generated by synthesizing the equivalent-to-text image of this embodiment is an example of the alternative data of the base class.

The pseudo-continual learning module 40 of the third embodiment includes both the equivalent-to-text image generation unit 47 and the synthetic image generation unit 46 and constructs the pseudo-continual learning task using an image produced by synthesizing the equivalent-to-text image generated by the equivalent-to-text image generation unit 47 using the synthetic image generation unit 46. The method of generating the equivalent-to-text image by the equivalent-to-text image generation unit 47 and the method of generating a synthetic image by the synthetic image generation unit 46 are as described above.

According to the third embodiment, it is possible to construct a pseudo-continual learning task including a wider variety of images by synthesizing a plurality of equivalent-to-text images. As a result, the GAT 44 can be trained more effectively so that the classification accuracy of the machine learning apparatus 100 can be further improved.

### Fourth Embodiment

Hereinafter, a fourth embodiment of the present invention will be described. In the drawings and description of the third embodiment, the same or equivalent constituting elements as those of the first embodiment are denoted by the same reference numerals. Duplicative explanations from the first embodiment are omitted as appropriate, and features different from those of the first and second embodiments will be highlighted.

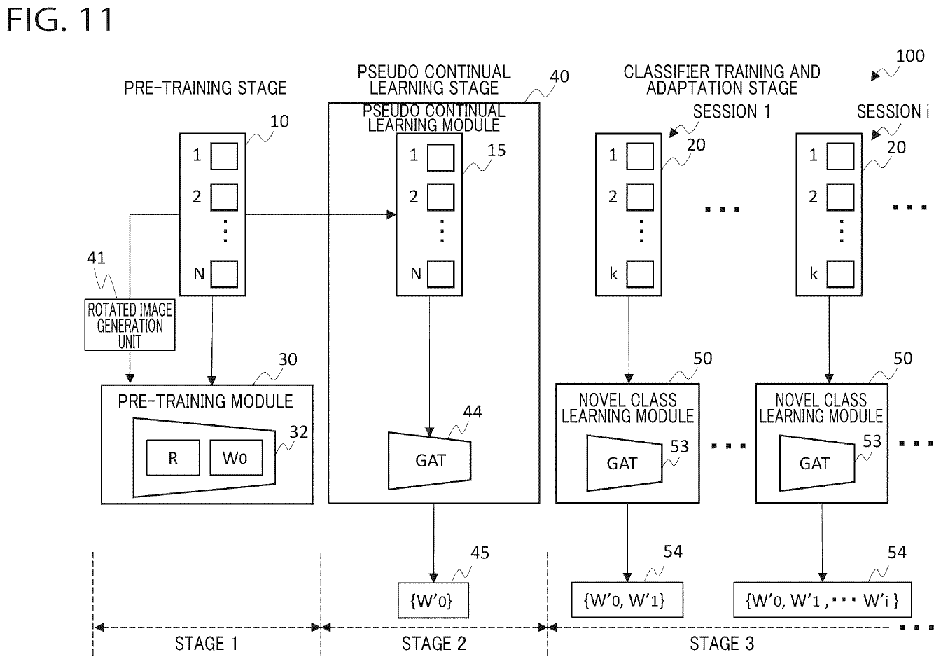

FIG. 11 illustrates the CEC method of the fourth embodiment. As shown in FIG. 11, the rotated image generation unit 41 generates a rotated image by rotating an image of the basic dataset 10 and inputs the rotated image to the pre-training module 30 in the pre-training stage. In the pre-training stage, therefore, the rotated image obtained by rotating the basic dataset 10 is input to the pre-training module 30 in addition to the basic dataset 10. The basic dataset 10 of the fourth embodiment is an example of the first data, and the rotated image of the fourth embodiment is an example of the second data.

In the pseudo-continual learning stage, on the other hand, the pseudo dataset 15 including the synthetic image or the equivalent-to-text image newly generated based on a plurality of data items of the base class is input to the GAT 44 as described above in the first-third embodiments. The synthetic image and the equivalent-to-text image of the fourth embodiment are examples of the third data. The third data can be, for example, the synthetic image, the equivalent-to-text image, the image produced by rotating the equivalent-to-text image, or the synthetic image from the equivalent-to-text image.

The first data, the second data and the third data are different data. When the second image is the equivalent-to-text image, for example, the third image may be the synthetic image or an equivalent-to-text image other than the equivalent-to-text image as the second image.

The pre-trained feature extraction units 42 and 51 of the pseudo-continual learning module 40 and the novel class learning module 50 of the fourth embodiment basically have the same configuration as the first-third embodiments but differ in that they are feature extractors R of the backbone CNN 32 pre-trained using the basic dataset 10 and the rotated image dataset from the basic dataset 10.

Incidentally, a rotated image of the base class is used in the pseudo-continual learning task in the conventional pseudo-continual learning method. Normally, the rotated image of the base class should also be learned in advance in order to improve the performance of the backbone CNN 32. If rotated image is learned in the pre-training stage, however, the same learning as in the GAT 44 will take place in the pseudo-continual learning stage. In other words, this ruins the premise that the backbone learns from an image of the base class in the pre-training stage and the GAT 44 learns from another image of the base class in the pseudo-continual learning stage. Therefore, the rotated image could not be used to pre-train the backbone CNN 32.

In this embodiment, on the other hand, a pseudo-continual learning task is constructed by newly generating a synthetic image or an equivalent-to-text image in the pseudo-continual learning stage. Therefore, an image different from the image used in pseudo-continual learning can be used as an image used to pre-train the backbone CNN 32. As a result, the rotated image can be used to pre-train the backbone CNN 32, and the classification accuracy can be expected to be improved as a result of improvement in the performance of the backbone CNN 32.

In the fourth embodiment, a rotated image produced by rotating one image of the basic dataset 10 is used as the second data in the pre-training stage. The embodiment is not limited thereto. For example, an image generated based on a plurality of data items of the basic dataset 10 (e.g., a synthetic image, a equivalent-to-text image, a synthetic image from the equivalent-to-text image, and a rotated image from the equivalent-to-text image) may be used. It can therefore be said that the pre-trained feature extraction units 42 and 51 are pre-trained using the data of the base class and the second data of the base class generated based on one or more data items of the base class.

In the first-fourth embodiments, examples of using the GAT in the pseudo-continual learning module 40 and the novel class learning module 50 have been shown, but the embodiments are not limited thereto. The requirement is that a graph model such as a GAT and a graph neural network is used.

The above-described various processes in the machine learning apparatus 100 can of course be implemented by hardware-based devices such as a CPU and a memory and can also be implemented by firmware stored in a read-only memory (ROM), a flash memory, etc., or by software on a computer, etc. The firmware program or the software program may be made available on, for example, a computer readable recording medium. Alternatively, the program may be transmitted and received to and from a server via a wired or wireless network. Still alternatively, the program may be transmitted and received in the form of data broadcast over terrestrial or satellite digital broadcast systems.

Described above is an explanation based on an exemplary embodiment. The embodiment is intended to be illustrative only and it will be understood by those skilled in the art that various modifications to combinations of constituting elements and processes are possible and that such modifications are also within the scope of the present invention.

What is claimed is:

1. A machine learning apparatus that learns data of a novel class with a smaller number of samples than data of a base class by continual learning, comprising:
a feature extraction unit that is pre-trained using the data of the base class and that receives an input of the data of the novel class to output a feature vector of the data of the novel class;
a weight calculation unit that calculates a classification weight of the novel class based on the feature vector; and
a graph model that receives an input of the classification weight of the novel class calculated and classification weights of all classes previously learned and is caused to adapt and reconstruct the classification weights thus input and to output reconstructed classification weights, the graph model being trained by pseudo continual learning using alternative data of the base class generated based on a plurality of data items of the base class to learn a dependency between the base class and the novel class by meta learning.

2. The machine learning apparatus according to claim 1,
wherein the alternative data is data generated by rotating a plurality of data items of the base class and synthesizing the plurality of data items rotated.

3. The machine learning apparatus according to claim 1 or 2, further comprising:
an image generation model that receives an input of text data to output image data,
wherein the image generation model is pre-trained using a plurality of data items of the base class, and
wherein the alternative data is the image data output from the image generation model by inputting text data that describes the base class to the image generation model.

4. A machine learning method that learns data of a novel class with a smaller number of samples than data of a base class by continual learning, comprising:
inputting the data of the novel class to a feature extraction unit pre-trained on the data of the base class, thereby causing the feature extraction unit to output a feature vector of the data of the novel class;
calculating a classification weight of the novel class based on the feature vector; and
inputting the classification weight of the novel class calculated and classification weights of all classes previously learned to a graph model trained by pseudo continual learning using alternative data of the base class generated based on a plurality of data items of the base class to learn a dependency between the base class and the novel class by meta learning, and causing the graph model to adapt and reconstruct the classification weights thus input and to output reconstructed classification weights.

5. A machine learning program for learning data of a novel class with a smaller number of samples than data of a base class by continual learning, the program comprising computer-implemented modules including:
a module that inputs the data of the novel class to a feature extraction unit pre-trained on the data of the base class, thereby causing the feature extraction unit to output a feature vector of the data of the novel class;
a module that calculates a classification weight of the novel class based on the feature vector; and
a module that inputs the classification weight of the novel class calculated and classification weights of all classes previously learned to a graph model trained by pseudo continual learning using alternative data of the base class generated based on a plurality of data items of the base class to learn a dependency between the base class and the novel class by meta learning, and causes the graph model to adapt and reconstruct the classification weights thus input and to output reconstructed classification weights.
